(19) United States
(12) Patent Application Publication
(10) Pub. No.: US 2025/0251591 A1
(43) Pub. Date: Aug. 7, 2025

(54) WAVEGUIDE FOR MIXED REALITY VIEWING

(71) Applicant: GOOGLE LLC, Mountain View, CA (US)

(72) Inventors: Andrew Logan, Waterloo (CA); Oscar Alberto Martinez, San Diego, CA (US); Thibault Louis David Leportier, Montreal (CA)

(21) Appl. No.: 18/434,243

(22) Filed: Feb. 6, 2024

(51) Int. Cl. G02B 27/00; G02B 27/01; G06F 3/01

(52) U.S. Cl. CPC G02B 27/0093; G02B 27/0172; G06F 3/013; G02B 2027/0174; G02B 2027/0178

(57) ABSTRACT

A gaze tracking system is disclosed for use in augmented reality or virtual reality headsets. The gaze tracking system uses a holographic optical element and a transparent waveguide to create a telecentric illumination and imaging system that facilitates accurate and reliable measurements of eye motion. The gaze tracking system uses the transparent waveguide, incorporated into the lens of the headset, with a holographic out-coupler to establish a virtual light source and detector directly in front of the eye, to facilitate an optimal view of the eye during measurement of eye motion.

### BACKGROUND

Augmented reality (AR) technology overlays digital content onto a real-world environment to provide an immersive experience for a user. Virtual reality (VR) provides an immersive experience for the user that is an alternative to the real-world environment. AR/VR headsets can be in the form of, for example, goggles or “smart” glasses that are electronically enhanced. For example, cameras, inertial measurement units (IMUs), and audio devices can be disposed on the headset. The cameras can project images onto a lens of the headset, providing a heads-up display (HUD). Another function of an AR/VR headset is gaze tracking, or eye tracking (ET), in which sensors are used to follow the direction of the user's vision.

### SUMMARY

The present disclosure describes methods and devices that can be used to monitor a user's gaze during an augmented reality or virtual reality experience. Gaze tracking devices, e.g., eye tracking devices, can be mounted to a mixed reality headset (e.g., an AR/VR headset), for example, as a feature of smart glasses. Some eye trackers include an illuminator in the arm or temple of the glasses that projects a light beam onto the lens. The light beam can then be reflected in the direction of the wearer's eye. The concepts that are described herein can be applied to a variety of computing devices that include an eye tracker. Although the description is generally directed to a mixed reality headset, the concepts can be applied to any type of computing device that uses eye tracking.

In some aspects, the techniques described herein relate to an apparatus, including: a transparent waveguide incorporated in a lens; a light source configured to transmit a light beam to the transparent waveguide; and a detector co-located with the light source, the transparent waveguide including: a transmission medium; an in-coupler configured to receive the light beam and couple the light beam into the transmission medium; and an out-coupler configured to diffract the light beam out of the transmission medium in collimated rays.

In some aspects, the techniques described herein relate to eyewear, including: a lens; a frame including a temple and an arm and, attached to the arm, a lens-supporting portion extending in a direction substantially transverse to the arm; and a telecentric illumination system, including: a transparent waveguide embedded in the lens, an in-coupler configured to receive an incident light beam and couple the incident light beam into the transparent waveguide; a telecentric out-coupler configured to diffract the incident light beam out of the transparent waveguide in collimated rays and to couple a collimated reflected light beam into the transparent waveguide; and an illuminator disposed in the frame, the illuminator including: a light source and configured to transmit an incident light beam from the light source to the in-coupler; and a detector configured to receive the collimated reflected light beam from the in-coupler.

In some aspects, the techniques described herein relate to a method of eye tracking, including: in-coupling a light beam into a transparent waveguide embedded in an eyeglass lens; transmitting the light beam through the transparent waveguide to an out-coupler; and out-coupling the light beam as collimated rays incident on an eye.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a pictorial perspective view of AR glasses, according to a possible implementations of the present disclosure.

FIG. 2 is a block diagram illustrating considerations and tradeoffs when designing a gaze tracking system, according to a possible implementations of the present disclosure.

FIG. 3 is a schematic diagram of an eye tracking system, according to a first implementations of the present disclosure.

FIG. 4 is a schematic diagram of an eye tracking system, according to a second implementations of the present disclosure.

FIG. 5 is a pictorial perspective view of the eye tracking system shown in FIG. 3, implemented with a prism coupler, according to a possible implementations of the present disclosure.

FIG. 6 is a side view of an eye illuminated by a light beam, according to a possible implementations of the present disclosure.

FIGS. 7A and 7B illustrate the effect of eye rotation on a collimated beam, according to a possible implementations of the present disclosure.

FIGS. 8A and 8B illustrate the effect of slippage on a collimated beam, according to a possible implementations of the present disclosure.

FIGS. 9A and 9B illustrate the combined effect of eye rotation and slippage on a collimated beam, according to a possible implementations of the present disclosure.

FIG. 10 is a flow chart for an eye tracking process, according to a possible implementation of the present disclosure.

FIG. 11 is a system block diagram of a computer system for implementing eye tracking process shown in FIG. 10, according to a possible implementation of the present disclosure.

The components in the drawings are not necessarily drawn to scale relative to each other. Like reference numerals designate corresponding parts throughout the several views.

### DETAILED DESCRIPTION

A gaze tracker used in a computing device (e.g., mixed reality headset (e.g., head mounted device), augmented reality (AR) glasses) is an eye tracking device that transmits a light beam toward the user's eye, and monitors light reflected and/or scattered from the eye. Such eye tracking devices can be mounted in the frame of, for example, AR glasses. However, separating the eye tracker from the visual line-of-sight may not provide the most accurate eye tracking data when the eye is not consistently in view of the eye tracking device. For the gaze tracker to be included as a core feature of AR glasses, accurate and reliable eye tracking is important in order for the AR glasses to be useful for a wide range of users.

Although the description below is generally directed to a mixed reality headset or AR glasses to clearly explain the concepts, the concepts described herein can be applied to any type of computing device that uses eye tracking. In other words, the eye tracking concepts that are described herein can be applied to a variety of computing devices that include an eye tracker.

At least one technical problem with wearable eye-tracking devices mounted on AR glasses is related to placement of an eye tracking device directly in front of the eye without obstructing, e.g., occluding, the wearer's view through the lens and without degrading the aesthetics of the AR glasses. At least another technical challenge associated with eye-tracking devices is that it can be difficult to distinguish between eye rotation and translation of the eye tracking hardware relative to the eye, e.g., slippage of the AR glasses on the face, which leads to a reduction in the accuracy of the eye tracker.

At least one technical solution to address these concerns is to incorporate into the lens of the AR glasses a transparent (e.g., see-through) waveguide that captures light transmitted from an optical transceiver located in the arm of the AR glasses, or within a computing device that includes an eye tracker. A waveguide is a structure that spatially confines a light beam to propagate within a particular material, preventing light energy from escaping the material. The waveguide can then channel the light beam in a particular direction. The transparent waveguide described herein is integral to the lens of the glasses so that the transparent waveguide is invisible to the wearer and therefore does not obstruct the wearer's vision. The transparent waveguide includes transparent optical elements, e.g., lenses, that effectively move the eye tracking function from the arm of the glasses to a location in front of the eye, to provide more accurate eye tracking. So, even though the eye tracking hardware (e.g., hardware used for signal processing) still resides in the arm of the glasses, optical components that are used to track eye motion are provided as transparent, invisible, elements in the transparent waveguide that is incorporated into the lens of the AR glasses.

Specifically, the transparent waveguide can direct light captured at the edge of the lens toward the lens (e.g., towards a center or other designated location of the lens), in front of (e.g., directly in front of) the eye. Then an out-coupler (OC) (e.g., a holographic out-coupler), also embedded in the lens, can be used to direct the light beam out of the AR glasses toward the wearer's eye. Specifically, the OC can collimate the light into parallel rays to track eye motion. Light scattered by the eye and periocular region is then coupled back into the transparent waveguide for return propagation to a photodetector virtually co-located or overlapping with the light source.

In some implementations, the OC is an out-coupler having a telecentric imaging optical function. That is, the OC can be configured to impart telecentric functionality onto the optical system. Telecentric lenses have an exit or entrance pupil at infinity, so that they can provide a constant magnification that does not change with depth of field. Telecentric lenses are also free of parallax, so that a position of an object seen from two different points when viewed through the telecentric lens will be consistent.

At least one technical effect of the collimated light beam is that it makes the eye tracker less sensitive to, e.g., more tolerant of, slippage of the position of the glasses on the user's head. That is, even if the glasses slip, the eye tracker will still work and maintain accuracy. With this apparatus, even though the light source is still located in the arm of the AR glasses, the incident collimated beam is transmitted from a point directly in front of the eye so that the collimated beam is substantially normal to the eye. The eye tracker therefore functions as though it is in front of (e.g., directly in front) of the eye. Eye motion can then be determined (e.g., deduced) from a ray analysis of the incident and scattered light.

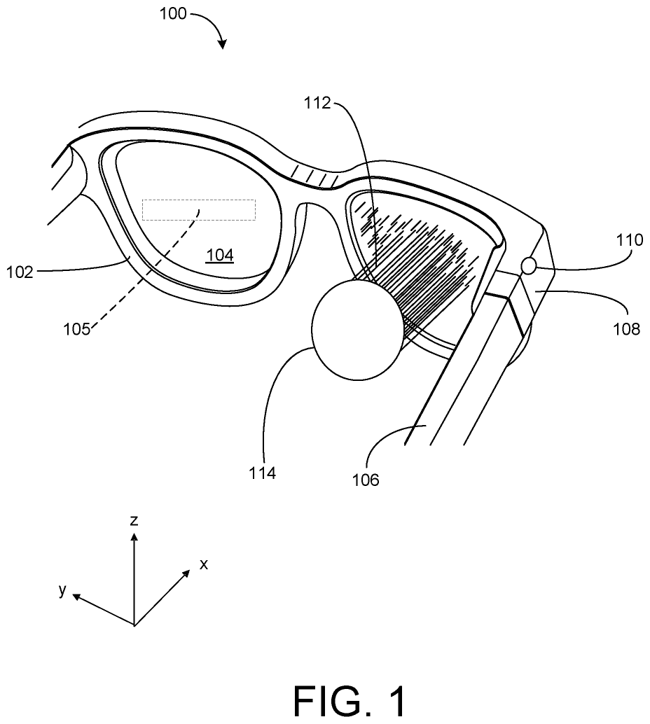

FIG. 1 shows a perspective view of a pair of immersive glasses 100 that include a gaze tracking feature embedded in the lens, according to some implementations of the present disclosure.

The immersive glasses 100 are eyewear, suitable for use as for example, AR glasses that superimpose information through a display within the immersive glasses 100 onto a real-world scene, or virtual reality (VR) goggles (e.g., a virtual reality headset) that immerse the wearer in a virtual world. This can be contrasted with ambient glasses (e.g., prescription eyeglasses with corrective lenses) which are configured to enhance visual perception of a user in the real world. Some implementations that include VR goggles can be configured (e.g., made large enough) to fit over a pair of glasses (e.g., prescription glasses, ambient glasses). AR glasses can be a lighter weight and/or less bulky option than VR goggles. The immersive glasses 100, when implemented as AR glasses or ambient glasses, can incorporate prescription lenses that are tailored to the wearer's vision so that they function as enhanced ambient glasses.

The immersive glasses 100 include a frame 102, lenses 104 (two shown) that each include a transparent waveguide 105 (one shown), arms 106 (one shown), and temples 108 (one shown). In some implementations, the frame 102 includes the arms 106 and the temples 108 as well as a lens-supporting portion attached to the arms and extending in a direction substantially transverse to the arm(s). As in the case of regular, or ambient glasses, the arms 106 hold the immersive glasses 100 in place on the wearer's head. However, in some implementations, the arms 106 and/or the temples 108 can also serve as a platform for various sensors and input/output (I/O) devices that provide information flow to and from the immersive glasses 100. For example, headsets and other wearable computing devices such as the immersive glasses 100 may include various types of electronic components for computation and both long-range and short-range radio frequency (RF) wireless communication.

Such electronic devices can include, for example, a world-facing camera, an input device, an RF wireless transceiver, e.g., a transmitter/receiver such as a Bluetooth communication transceiver, light emitting diodes (LEDs), sensors, e.g., IMUs, audio devices e.g., microphones, speakers, and so on. In some implementations, the arms 106 and/or the temples 108 can include eye tracking components such as a light source, e.g., an illuminator 110, and a light sensor/receiver, e.g., an eye-tracking camera. The illuminator 110 can be disposed in the frame 102, e.g., in the temple 108 of the frame 102, or in the arm 106 of the frame 102. The illuminator 110 can be configured to transmit an incident light beam 111 in the direction of the adjacent lens 104. In some implementations, the illuminator 110 can be a transceiver, that is, a transmitter (source) and a receiver (detector) that are co-located in the arm 106. In some implementations, there may be a one-to-one correspondence between pixels, or picture elements, of the detector and rays in the incident light beam 111.

The lens 104 and the transparent waveguide 105 are made of a transparent material or materials, e.g., glass or one or more polymer materials, that transmit light toward the user's eye. Optical elements within the lens 104 can receive the incident light beam and can then redirect the light rays, using the transparent waveguide 105, so that a collimated light beam 112 emerges from the lens 104. In some implementations, boundaries of the transparent waveguide 105 can be delineated by variation in the index of refraction within the material of the lens 104. The collimated light beam 112 is a beam of parallel light rays that propagate toward the wearer's eye 114. The collimated light beam 112 propagates in a direction substantially normal (perpendicular) to the surface of the lens 104 and to the surface of the wearer's eye 114. When the lens 104 is substantially aligned with the y-z plane, the propagation direction is along the x-axis as shown in FIG. 1. Positioning the sensors and I/O devices on an arm 106 of the glasses can be preferable to previous designs in which such devices were placed along a rim of the frame 102, around the lenses 104.

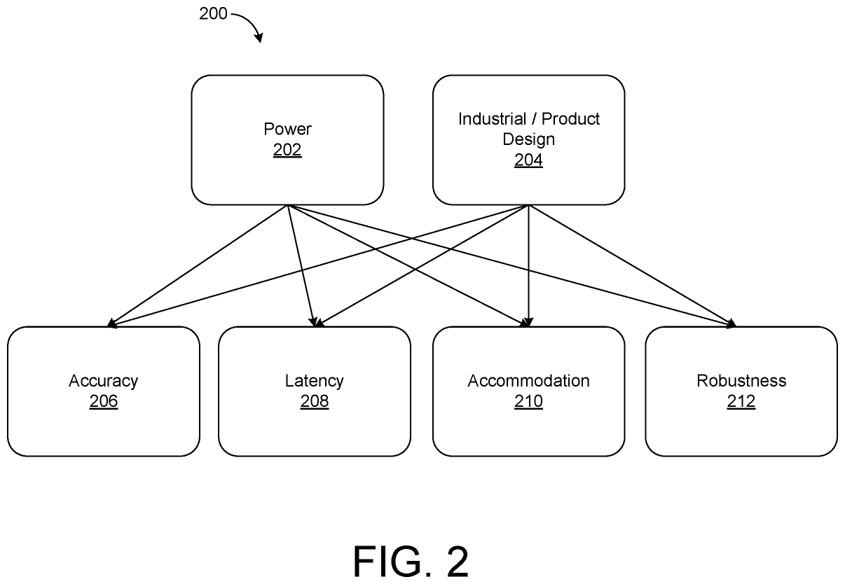

FIG. 2 is a block diagram 200 illustrating various design considerations and tradeoffs influencing the design of AR/VR headsets, according to some implementations of the present disclosure. FIG. 2 illustrates how new approaches to gaze tracking as described herein can balance competing design considerations. For example, repositioning hardware elements within the frame of the AR/VR headset as shown in FIG. 1 can affect slippage of the headset, thereby reducing robustness of the design. Adding the transparent waveguide 105 to the lens 104 can compensate for this effect.

With reference to the top row of the block diagram 200, two attributes of an AR/VR headset to consider in the design phase are power 202 and industrial/product design 204. The power 202 for an AR/VR headset refers to battery capacity and battery lifetime, or time between charges, vs. battery size and compactness. Industrial/product design 204 refers to the form factor, e.g., dimensions and shape, of the headset, as well as materials used in fabricating the headset. The form factor is subject to human factors limitations. The form factor can constrain the wearer's view, and can also influence the number and placement of components needed to provide various headset features. A desirable arrangement of components may pose a challenge to the industrial design. With reference to the bottom row of the block diagram 200, four effects of the attributes of an AR/VR headset include accuracy 206, latency 208, accommodation 210, and robustness 212. Design of AR/VR headsets may involve tradeoffs among these four effects.

The accuracy 206 refers to how accurately the headset transmits sensory information to the wearer, and how accurately the headset receives information and/or commands from the wearer. For example, the accuracy 206 can be influenced by whether or not the wearer receives an unobstructed view of key features and whether or not the headset receives enough information to calculate a unique pose estimate of the wearer's head position.

The latency 208 refers to responsiveness of the headset equipment. For example, the time interval between when the headset performs a measurement to when the equipment responds to that measurement can have a latency of about 40 ms to about 150 ms, while the latency for behavior tracking can be much faster, e.g., less than 40 ms.

The accommodation 210 refers to how well the headset accommodates a variety of different wearers. That is, how many people in the general population, with variations in eye size, eye shape, and so forth, would feel comfortable using the headset (“population coverage”), and whether or not the headset accommodates, e.g., covers, or fits over, the wearer's ambient eyewear.

The robustness 212 refers to the resilience of the headset to expected everyday perturbations, for example, changes in ambient light levels, and how well the headset remains in place on the user's head. Such considerations can include, for example, how likely the headset is to slip off the wearer's head when being worn continuously (“slippage”), and what is needed to re-mount the headset, since it will not be put back in precisely the same place each time the user removes and replaces the headset. Components may need to be added to achieve an acceptable level of robustness 212. For example, redundant light sources and detectors can be added to the headset for improved accommodation and robustness.

Some implementations as described herein may relax tensions between industrial/product design 204, and factors such as accommodation 210, and robustness 212. It is desirable for a new approach to avoid, or overcome, these competing constraints. For example, changing the placement of an eye tracking device on the frame of the AR/VR headset may affect the balance of the frame causing increased slippage and a reduction in robustness. By adding components to the lens, the balance may be stabilized. Features of the architecture described herein include co-locating the source and detector in the arm 106 instead of the frame 102, and introducing optical elements into the lens to create a virtual camera placement directly in front of the eye, and at optical infinity.

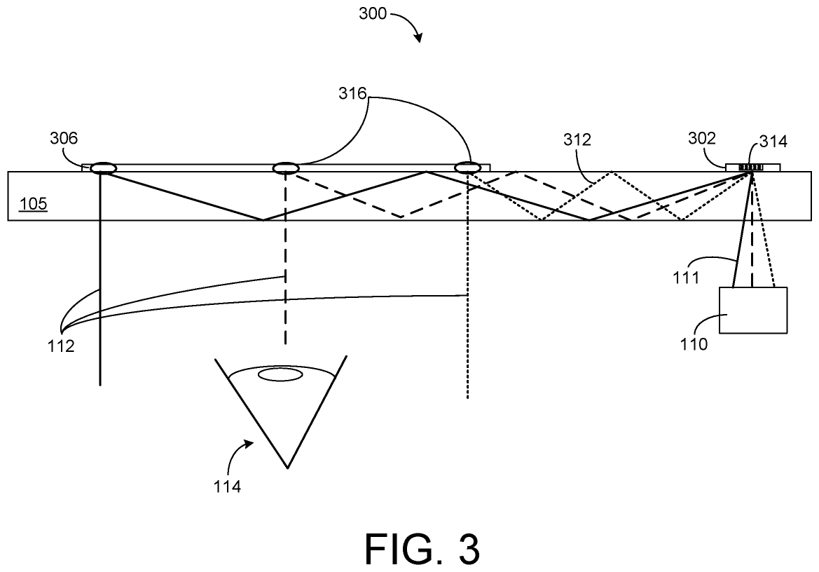

FIG. 3 is a schematic diagram showing an eye tracking apparatus 300, according to some implementations of the present disclosure. The eye tracking apparatus 300 includes the illuminator 110, an in-coupler 302, a transparent waveguide 105, and an out-coupler 306. The eye tracking apparatus 300 controls bi-directional propagation of the incident light beam 111 and light rays 312 between the illuminator 110 and the wearer's eye 114 to perform a gaze tracking feature of the immersive glasses 100.

The illuminator 110 transmits the incident light beam 111 into the transparent waveguide 105 toward the in-coupler 302. The in-coupler 302 receives the incident light beam 111 from the illuminator 110 and re-directs the incident light beam 111 for propagation as light rays 312 within the transparent waveguide 105 toward the out-coupler 306. The out-coupler 306 can be a holographic out-coupler (HOC) or another type of out-coupler. The out-coupler 306 re-directs the light rays 312 within the transparent waveguide 105 to form the collimated light beam 112 directed toward the wearer's eye 114. The collimated light beam 112 reflects off the wearer's eye 114, and the reflected light is then coupled back into the transparent waveguide 105 by the outcoupler 306. The reflected light then propagates through the transparent waveguide 105 to the in-coupler 302. The reflected light is then captured by a detector co-located with the illuminator 110.

In some implementations, the incident light beam 111 can have a wavelength in the near infrared (NIR) portion of the electromagnetic spectrum. In some implementations, the wavelength can range from about 850 nm to about 940 nm. Alternatively, the incident light beam 111 can have a longer wavelength, e.g., 1000 nm or longer. A longer wavelength source may be more difficult to obtain, but may have some advantages. In some implementations, the illuminator 110 can include a single emitter. In some implementations, the detector can include, for example, one or more sensors, photodetectors, or cameras. In some implementations, the detector can be implemented as a digital eye-tracking camera having a multi-pixel image sensor in which each pixel corresponds to a single ray of the collimated reflected light beam. The architecture shown in FIG. 3 supports different imaging methodologies at the detector, including, for example, contact image sensor (CIS) imaging, event-based vision sensor (EVS) imaging and micro-electromechanical sensor (MEMS) based imaging.

In some implementations, the in-coupler 302 can include a customizable diffraction grating 314 that diffracts the transmitted light beam 310 to produce the light rays 312. The customized diffraction grating 314 can include lens materials such as glass or a photopolymer. In some implementations, one or more photopolymers used in fabricating the customizable diffraction grating 314 can be a near-infrared sensitive photopolymer. Dimensions, e.g., spacings, of the customizable diffraction grating 314 can be tailored to diffract the incident light beam 111 into the transparent waveguide 105. In some implementations, the transparent waveguide 105 can include a transmission medium, e.g., lens material, such as a glass plate, or a polymer, that is transparent to relevant wavelengths. Dimensions of the transparent waveguide 105 may depend on the size and design of the immersive glasses 100, e.g., the thickness of the lenses 104, the distance between the temples 108, the shape of the lenses 104, the location of the center of the lenses 104, and so on. In some implementations, a glass lens can have a thickness in a range of about 300 μm to about 700 μm to provide sufficient mechanical rigidity.

In some implementations, a photopolymer can be laminated to the lens material, e.g., to the glass waveguide. One or more photopolymers used in fabricating the transparent waveguide 105 can be a near-infrared sensitive photopolymer. The photopolymer can have a thickness of about 50 μm.

In some implementations, the out-coupler 306 can be a volume hologram out-coupler that includes a holographic optical element (HOE) 316. Holographic optical elements are optical elements, e.g., lenses, that manipulate light using diffraction, instead of bending the light rays by reflection or refraction. Some regions of the photopolymer can have HOEs recorded within them. The HOEs can be arranged in a regular pattern, or array, e.g., as a matrix. In some implementations, the out-coupler 306 can be a narrow bandwidth HOE outcoupler such that only light rays that satisfy the Bragg condition are efficiently coupled into or out of the transparent waveguide 105. Light rays having a wavelength, or a propagation direction that do not satisfy the Bragg condition will not interact with the HOE. In some implementations, the out-coupler 306 can include a customized diffraction grating, e.g., a holographic diffraction grating. In some implementations, the HOEs 316 act as collimating lenses. The HOEs 316 can exhibit telecentricity so as to produce the collimated light beam 112 that exits the transparent waveguide 105. In some implementations, the HOEs 316 can be spectrally selective so that only selected wavelengths of light are included in the collimated light beam 112. For example, the HOEs can have a narrow bandwidth that includes near infrared (NIR) light so that only the light that contributes to the collimated beam will be diffracted.

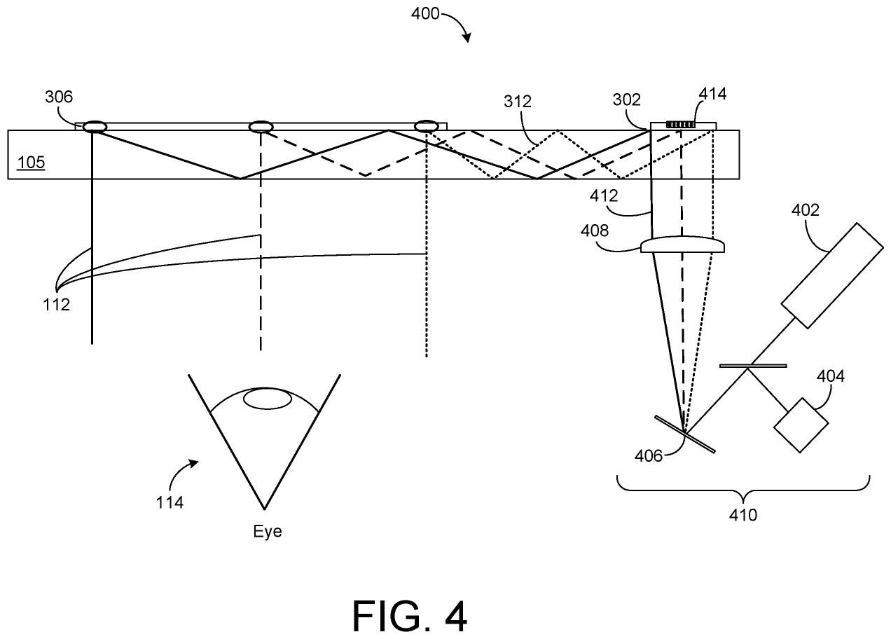

FIG. 4 is a schematic diagram showing an eye tracking apparatus 400, according to some implementations of the present disclosure. In the eye tracking apparatus 400, a source having a narrow spectral bandwidth, such as a laser-based illuminator 410, can be used as the illuminator 110. In some implementations, the laser-based illuminator 410 can include a laser source 402, a photodetector 404 one or more mirrors 406, e.g., scanning mirrors, and one or more optical elements 408, e.g., lenses, to create a collimated incident light beam 412. In some implementations, a single photodiode can be used as the photodetector 404 and/or a microelectromechanical system (MEMs) scanner can be used to form a single pixel scanning imaging system. Other components of the eye tracking apparatus 400 can be similar to those of the eye tracking apparatus 300 shown in FIG. 3.

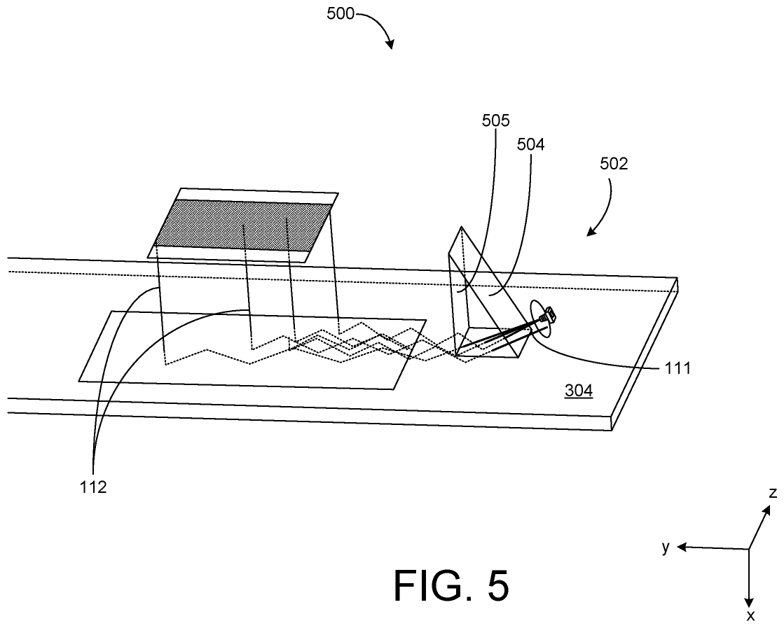

FIG. 5 is a pictorial view of an eye tracking apparatus 500, according to some implementations of the present disclosure. The eye tracking apparatus 500 includes a prism coupler 502 having a prism 504. In the eye tracking apparatus 500, the prism coupler 502 can be provided as an example of an in-coupler 302 used to efficiently capture light from the illuminator 110 (shown in FIG. 1). The prism coupler 502 couples the incident light beam 111 into the waveguide 105 through the prism 504. The prism 504 can have an index of refraction matched to the waveguide 105. Nevertheless, the prism 504 may introduce aberrations, e.g., astigmatism, that can degrade the quality of an image produced by the eye tracking apparatus 500. Aberrations introduced by the prism 504 can be corrected by adjusting the curvature of selected surfaces of the prism 504.

In some implementations, the prism coupler 502 can be modified to include enhancements that can correct for aberrations such as astigmatism. The prism coupler 502 has an entrance surface 503 at which the incident light beam 111 enters the waveguide 105 and an exit surface 505 at which the incident light beam 111 exits the prism coupler 502. For example, in some implementations, the prism coupler 502 can be modified to include a prism 504 having a toroidal surface. In some implementations, the prism coupler 502 can be modified to include a spherical cylindrical surface on the exit surface 505. In some implementations, the prism coupler 502 can be modified to include one or more custom lenses. In some implementations, the curvature of the exit surface 505 can correct astigmatism of the eye tracking apparatus 500 to sharpen a final image perceived by the wearer.

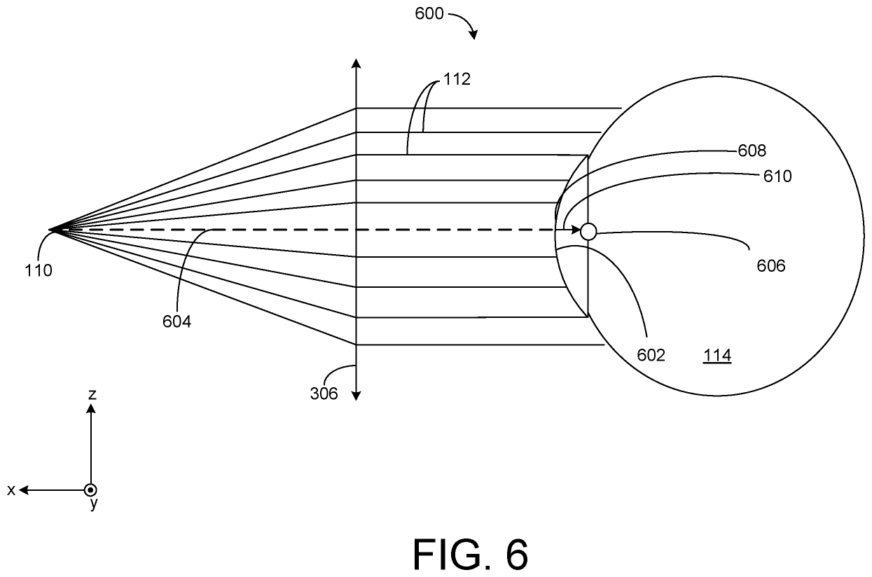

FIG. 6 illustrates a technique for determining a gaze direction by measuring eye rotation, according to some implementations of the present disclosure. FIG. 6 shows rays of the collimated light beam 112 reflecting from the wearer's eye 114 (10 rays shown). While the source and detector of the light are physically co-located (e.g., overlap) at the illuminator 110 (shown in FIGS. 1 and 3), the out-coupler 306 serves to create a virtual source/detector, e.g., virtual camera, co-located directly in front of the lens. From this location, the out-coupler 306 shown in FIG. 3 and FIG. 4 serves as a collimator producing the collimated light beam 112. Rays in the collimated light beam 112 are effectively generated at optical infinity relative to the wearer's eye 114. The ray along the central axis 804 is the ray that will return to the detector, and the ray that will represent the center of the pupil, and generate a bright corneal ‘glint’ in the pupil (e.g., middle or other location of the pupil). As shown in FIG. 6, the collimated light beam 112 is directed to (e.g., centered on) the wearer's eye 114.

FIG. 6 also shows details of the anatomy of the wearer's eye 114, including a cornea 602 aligned with the central axis 604, and a pupil center 606 around which the pupil, that is, a black central portion of the eye, expands and contracts, e.g., dilates, to adjust an amount of light entering the main body of the wearer's eye 114. The cornea 602 covers a portion of the front surface of the wearer's eye 114. Light enters and leaves the wearer's eye 114 through the cornea 602 and the pupil. The location of the pupil center 606 can be calculated once the edges of the pupil are detected.

Specular reflection, normal to the surface of the cornea 602 is the definition of “glint,” and the point of specular reflection can be referred to as the “glint center” 608. In FIG. 6, in which the collimated light beam 112 is directed to (e.g., centered), the glint ray is along the central axis 604. A vector drawn from the glint center 608 to the pupil center 606 can be referred to as a glint-pupil vector 610. By tracking the glint and/or the glint-pupil vector 610 as described below, an estimated gaze direction can be calculated.

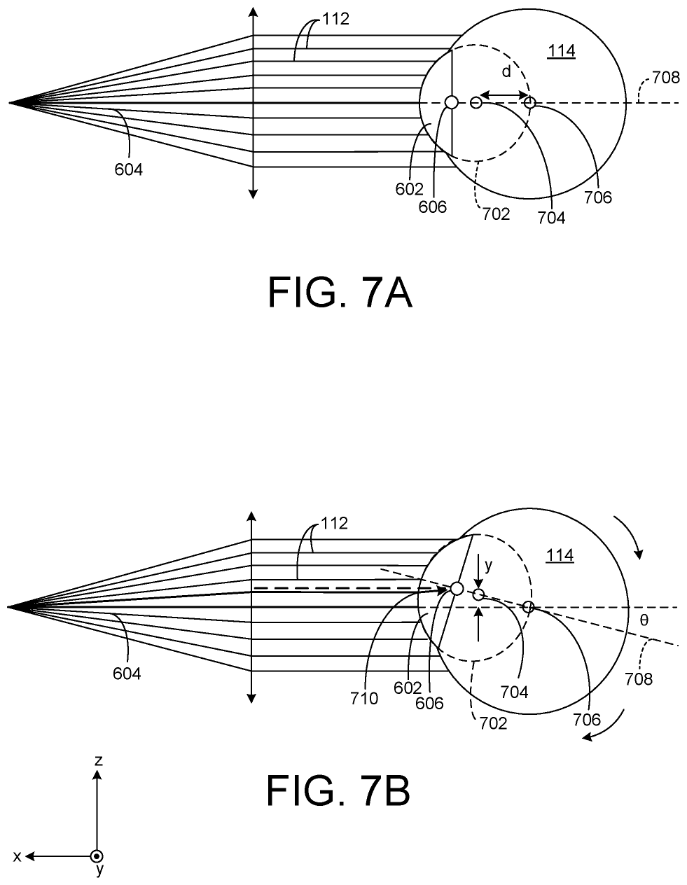

FIGS. 7A and 7B illustrate how eye rotation affects glint, according to some implementations of the present disclosure. FIG. 7A reproduces FIG. 6, showing additional detail of the cornea 602. Specifically, FIG. 7A shows the orientation of a corneal sphere 702, a corneal center 704, a rotational center 706, and a corneal axis 708, when the wearer's eye 114 is directed straight ahead along the central axis 604. The corneal sphere 702 defines a radius of curvature of the cornea 602, which differs from that of the wearer's eye 114 as a whole. Accordingly, the corneal center 704, at the center of the corneal sphere 702, is offset by a distance d from the rotational center 706 of the eye 114. The corneal axis 708 joins the corneal center 704 and the rotational center 706, and tracks the direction of the glint. In FIG. 7A, the ray along the central axis 604 normal to the cornea 602 defines the glint.

FIG. 7B shows the orientation of the corneal center 704 and the corneal axis 708 following rotation of the wearer's eye 114 in a clockwise direction. The wearer's eye 114 rotates through an angle θ around the rotational center 706, to look upwards. While the rotational center 706 remains stationary during the rotation, the corneal center 704 is translated vertically by a distance y, relative to its previous position. The corneal axis 708 is offset from the central axis 604 by the angle θ, thus changing the position of the pupil center 606 as well as the position of the corneal center 704. In some implementations, for every degree of rotation of the angle θ, the linear translation of the corneal center 704 is about 100 μm. In FIG. 7B, the ray normal to the cornea 602 that defines the glint, shown in bold, now lies above the central axis 604. The ray that intersects the pupil center 606 is shown as a bold dashed line. The two rays no longer coincide. Consequently, since both the glint and the pupil center 606 have moved with eye rotation, the wearer's gaze can be tracked by tracking the glint-pupil vector 610.

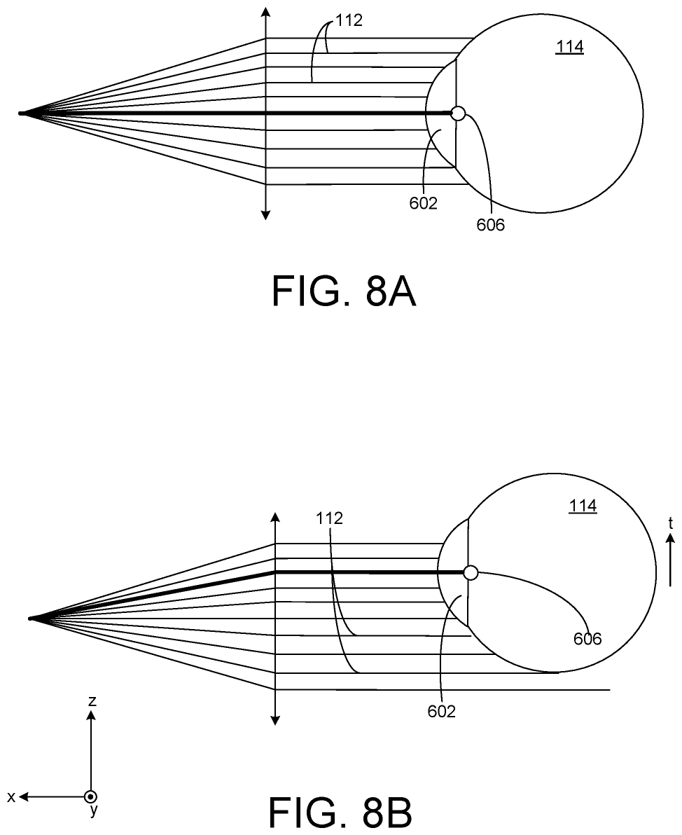

FIGS. 8A and 8B illustrate how eye translation affects glint, according to some implementations of the present disclosure. FIG. 8A duplicates the starting point shown in FIGS. 6 and 7A, in which the collimated light beam 112 is centered on the wearer's eye, for comparison against FIG. 8B. With reference to FIG. 1 and FIG. 8B, a position of the wearer's eye 114 can experience translational motion through a vertical distance t in the +2-direction, relative to the collimated light beam 112. Translation of the wearer's eye 114 can occur while looking straight ahead if, for example, the immersive glasses 100 shift slightly, relative to the wearer's face. This situation can be referred to as “slippage” of the frame 102. When slippage occurs, an upper portion of the cornea may not be illuminated, while some of the lower light rays of the collimated light beam 112 may bypass the wearer's eye 114. In some implementations, the immersive glasses 100 are configured so that the eye remains fully illuminated for any expected slippage position.

A comparison of FIG. 8A with FIG. 8B shows that the glint ray, e.g., the ray that is normal to the cornea, coincides with the ray that intersects the pupil center 606. Thus, the glint and the pupil center are co-located along the same ray (shown in bold), and therefore coincide at the image plane. The fact that the glint position relative to the pupil, e.g., the glint-pupil vector 610, is invariant as a function of slippage means that gaze vector estimates can be effectively determined regardless of slippage. This is because, as the eye translates within the field of view of the imager, the glint-pupil vector remains unchanged. Therefore although the glasses have slipped, the gaze angle relative to the glasses is still valid.

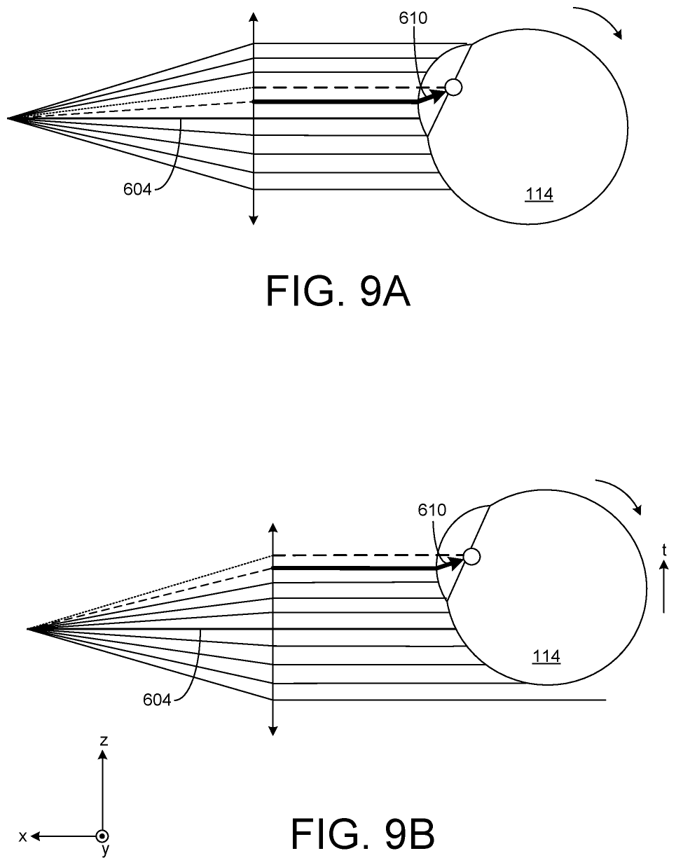

FIGS. 9A and 9B illustrate how a combination of eye rotation and eye translation affects the glint pupil vector, according to some implementations of the present disclosure. FIG. 9A illustrates the effect of eye rotation, e.g., looking upward, and FIG. 9B illustrates the effect of both eye rotation and eye translation. Comparing FIG. 9A with FIG. 9B, the glint-pupil vector 610 has the same length and orientation, so the glint-pupil vector 610 can be used to estimate the rotational component, independent of translation, e.g., slippage. Put differently, the same gaze angle, or eye rotation angle, yields the same glint-pupil vector regardless of the location of the eye.

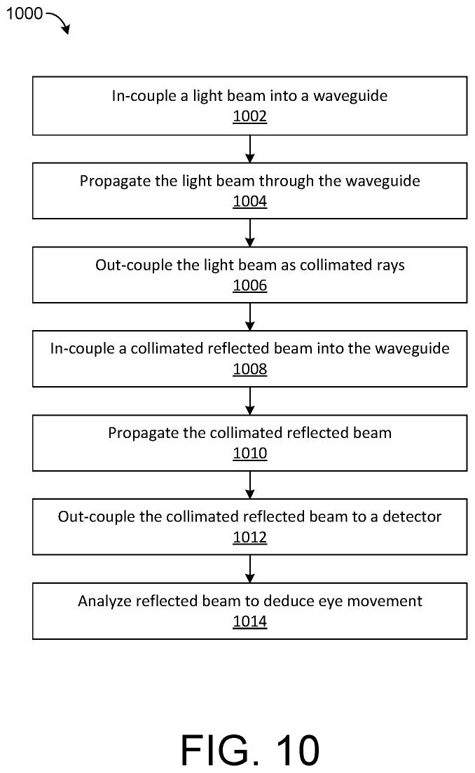

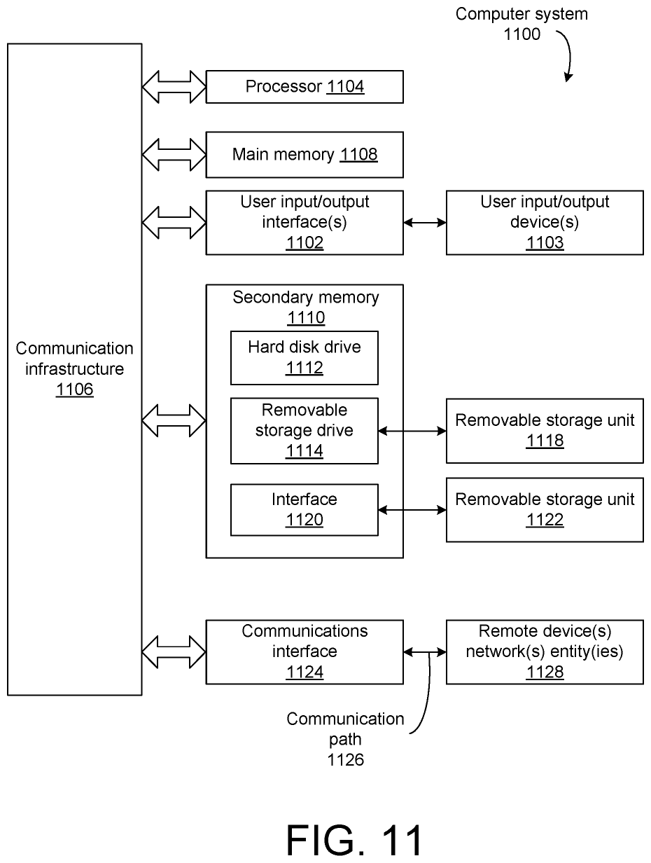

FIG. 10 is a flow chart illustrating a method 1000 of gaze tracking for use in AR and VR headsets, according to some implementations of the present disclosure. Operations of the method 1000 can be performed in a different order, or not performed, depending on specific applications. It is noted that the method 1000 may not result in a comprehensive gaze-tracking process. Accordingly, it is understood that additional processes can be provided before, during, or after the method 1000, and that some of these additional processes may be briefly described herein. The operations 1002-1014 can be carried out by components of AR glasses, to perform gaze tracking, according to the implementations described above, with reference to FIGS. 1-5, 6, 7A, 7B, 8A, 8B, 9A, and 9B with reference to a computing system 1100 as shown in FIG. 11 and described below. In some implementations, the method 1000 can improve gaze tracking accuracy and reliability over previous methods.

At 1002, the method 1000 includes in-coupling a light beam into a waveguide, according to some implementations of the present disclosure. In some implementations, the light beam, can be a near-infrared light beam generated by the illuminator 110 or by the laser-based illuminator 410, and directed into the transparent waveguide 105 by the in-coupler 302.

At 1004, the method 1000 includes propagating the light beam through the waveguide, e.g., the transparent waveguide 105, embedded in a lens of the immersive glasses 100, according to some implementations of the present disclosure.

At 1006, the method 1000 includes out-coupling the light beam from the waveguide 105 as collimated rays toward a wearer's eye, according to some implementations of the present disclosure. In some implementations, the collimated rays are generated directly in front of the eye, by the out-coupler 306, which may be a holographic out-coupler.

At 1008, the method 1000 includes in-coupling a collimated beam reflected from the wearer's eye into the transparent waveguide 105, according to some implementations of the present disclosure. Scattered rays in the collimated beam that are not collinear with the collimated rays incident on the eye may not satisfy coupling conditions of the HOE and may not be in-coupled into the transparent waveguide 105. Instead, such non-collinear rays may pass, un-diffracted, through the transparent waveguide 105.

At 1010, the method 1000 includes propagating the collimated reflected beam through the transparent waveguide 105, according to some implementations of the present disclosure.

At 1012, the method 1000 includes out-coupling the collimated reflected beam from the transparent waveguide 105 to a detector, according to some implementations of the present disclosure. In some implementations, the detector can be co-located with the illuminator 110.

At 1014, the method 1000 includes analyzing the reflected beam to deduce eye movement, according to some implementations of the present disclosure. In some implementations, analyzing the reflected beam can include use of algorithms such as, for example, a glint-pupil regression model, or other model, that can be executed using the computing system 1100.

FIG. 11 is an illustration of an example computing system 1100 in which various embodiments of the present disclosure can be implemented. The computing system 1100 can be any well-known computing system capable of performing the functions and operations described herein. For example, and without limitation, the computing system 1100 can provide a hardware platform for implementing algorithms to execute the eye tracking scheme described above. The computing system 1100 can be used, for example, to execute one or more operations in the method 1000, which describes directing, sensing, and analyzing a light beam for eye tracking in AR glasses. In some implementations, the computing system 1100 can be fabricated on the same substrate as the illuminator 110 and light sensors, e.g., the transceiver in the eye tracking apparatus 300. In some implementations, the computing system 1100 can be a separate apparatus that is coupled to the eye tracking apparatus 300, and to report measurements and/or analysis data characterizing the operations and behavior of the eye tracking apparatus 300.

The computing system 1100 includes one or more processors (also called central processing units, or CPUs), such as a processor 1104. The processor 1104 is connected to a communication infrastructure or bus 1106. The computing system 1100 also includes input/output device(s) 1103, such as monitors, keyboards, pointing devices, etc., that communicate with a communication infrastructure or bus 1106 through input/output interface(s) 1102. The processor 1104 can receive instructions to implement functions and operations described herein—e.g., method 1000 of FIG. 10—via input/output device(s) 1103. The computing system 1100 also includes a primary or main memory 1108, such as random access memory (RAM). The main memory 1108 can include one or more levels of cache. The main memory 1108 has stored therein control logic (e.g., computer software) and/or data. In some embodiments, the control logic (e.g., computer software) and/or data can include one or more of the operations described above with respect to the method 1000 of FIG. 10.

The computing system 1100 can also include one or more secondary storage devices or secondary memory 1110. The secondary memory 1110 can include, for example, a hard disk drive 1112 and/or a removable storage device or drive 1114. The removable storage drive 1114 can be a floppy disk drive, a magnetic tape drive, a compact disk drive, an optical storage device, tape backup device, and/or any other storage device/drive.

The removable storage drive 1114 can interact with a removable storage unit 1118. The removable storage unit 1118 includes a computer usable or readable storage device having stored thereon computer software (control logic) and/or data. The removable storage unit 1118 can be a floppy disk, magnetic tape, compact disk, DVD, optical storage disk, thumb drive, and/or any other computer data storage device. The removable storage drive 1114 reads from and/or writes to removable storage unit 1118 in a well-known manner.

According to some embodiments, the secondary memory 1110 can include other means, instrumentalities or other approaches for allowing computer programs and/or other instructions and/or data to be accessed by the computing system 1100. Such means, instrumentalities or other approaches can include, for example, a removable storage unit 1122 and an interface 1120. Examples of the removable storage unit 1122 and the interface 1120 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface. In some embodiments, the secondary memory 1110, the removable storage unit 1118, and/or the removable storage unit 1122 can include one or more of the operations described above with respect to the method 1000 of FIG. 10.

The computing system 1100 can further include a communication or network interface 1124. The communications interface 1124 enables the computing system 1100 to communicate and interact with any combination of remote devices, remote networks, remote entities, etc. (individually and collectively referenced by remote devices 1128). For example, the communication interface 1124 can allow the computing system 1100 to communicate with the remote devices 1128 over a communications path 1126, which can be wired and/or wireless, and which can include any combination of LANs, WANs, the Internet, etc. Control logic and/or data can be transmitted to and from the computing system 1100 via the communications path 1126.

The operations in the preceding embodiments can be implemented in a wide variety of configurations and architectures. Therefore, some or all of the operations in the preceding embodiments—e.g., the method 1000 of FIG. 10—can be performed in hardware, in software or both. In some embodiments, a tangible apparatus or article of manufacture comprising a tangible computer useable or readable medium having control logic (software) stored thereon is also referred to herein as a computer program product or program storage device. This includes, but is not limited to, the computing system 1100, the main memory 1108, the secondary memory 1110 and the removable storage units 1118 and 1122, as well as tangible articles of manufacture embodying any combination of the foregoing. Such control logic, when executed by one or more data processing devices (such as the computing system 1100), causes such data processing devices to operate as described herein.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used in this specification, a singular form may, unless definitely indicating a particular case in terms of the context, include a plural form. Spatially relative terms (e.g., “over,” “above,” “upper,” “under,” “beneath,” “below,” “lower,” and so forth) may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. In some implementations, the relative terms above and below can, respectively, include vertically above and vertically below. In some implementations, the term “adjacent” can include laterally adjacent to or horizontally adjacent to.

In some implementations of the present disclosure, the terms “about” and “substantially” can indicate a value of a given quantity that varies within 20% of the value (for example, ±1%, ±2%, ±3%, ±4%, ±5%, ±10%, ±20% of the value). These values are merely examples and are not intended to be limiting. The terms “about” and “substantially” can refer to a percentage of the values as interpreted by those skilled in relevant art(s) in light of the teachings herein.

Some implementations may be executed using various semiconductor processing and/or packaging techniques. Some implementations may be executed using various types of semiconductor processing techniques associated with semiconductor substrates including, but not limited to, for example, Silicon (Si), Gallium Arsenide (GaAs), Gallium Nitride (GaN), Silicon Carbide (SiC) and/or so forth.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

It is to be appreciated that the Detailed Description section, and not the Abstract section, is intended to be used to interpret the claims. The Abstract section may set forth one or more but not all possible embodiments of the present disclosure as contemplated by the inventor(s), and thus, are not intended to limit the subjoined claims in any way.

1. An apparatus, comprising:
a transparent waveguide incorporated in a lens;
a light source configured to transmit a light beam to the transparent waveguide; and
a detector co-located with the light source, the transparent waveguide including:
a transmission medium;
an in-coupler configured to receive the light beam and couple the light beam into the transmission medium; and
an out-coupler configured to diffract the light beam out of the transmission medium in collimated rays.

2. The apparatus of claim 1, wherein the out-coupler is configured with a holographic optical element.

3. The apparatus of claim 1, wherein the out-coupler is a volume hologram out-coupler equipped with a customizable diffraction grating.

4. The apparatus of claim 1, wherein the light beam is a near-infrared light beam.

5. The apparatus of claim 1, wherein the in-coupler is a prism that has an index of refraction matched to an index of refraction of the transparent waveguide.

6. The apparatus of claim 1, wherein the transmission medium includes a transparent photopolymer material.

7. Eyewear, comprising:
a lens;
a frame including a temple and an arm and, attached to the arm, a lens-supporting portion extending in a direction substantially transverse to the arm; and
a telecentric illumination system, including:
a transparent waveguide embedded in the lens,
an in-coupler configured to receive an incident light beam and couple the incident light beam into the transparent waveguide;
a telecentric out-coupler configured to diffract the incident light beam out of the transparent waveguide in collimated rays and to couple a collimated reflected light beam into the transparent waveguide; and
an illuminator disposed in the frame, the illuminator including:
a light source and configured to transmit an incident light beam from the light source to the in-coupler; and
a detector configured to receive the collimated reflected light beam from the in-coupler.

8. The eyewear of claim 7, wherein the detector is implemented as a digital eye-tracking camera having a multi-pixel image sensor in which each pixel corresponds to a single ray of the collimated reflected light beam.

9. The eyewear of claim 7, wherein the eyewear is suitable for use in an augmented reality system.

10. The eyewear of claim 7, wherein the eyewear is suitable for use in a virtual reality system.

11. The eyewear of claim 7, wherein the eyewear is suitable for use as ambient eyewear.

12. The eyewear of claim 7, wherein the lens is configured as a corrective lens.

13. The eyewear of claim 7, wherein the frame accommodates electronic components including at least one of a world-facing camera, an input device, a Bluetooth communication transceiver, or an audio device.

14. The eyewear of claim 7, wherein the illuminator is disposed in the temple.

15. The eyewear of claim 7, wherein the illuminator is disposed in the arm.

16. A method of eye tracking, comprising:
in-coupling a light beam into a transparent waveguide embedded in an eyeglass lens;
transmitting the light beam through the transparent waveguide to an out-coupler; and
out-coupling the light beam as collimated rays incident on an eye.

17. The method of claim 16, wherein transmitting the light beam includes transmitting a near infrared light beam.

18. The method of claim 16, wherein out-coupling the light beam as collimated rays includes out-coupling by a holographic out-coupling device.

19. The method of claim 16, further comprising:
in-coupling a reflected light beam of collimated rays from the eye into the transparent waveguide;
transmitting the reflected light beam of collimated rays through the transparent waveguide; and
out-coupling the reflected light beam of collimated rays to a detector of an eye-tracking camera.

20. The method of claim 19, wherein the detector includes a plurality of pixels, each pixel of the plurality of pixels configured to receive a single collimated ray from the reflected light beam of collimated rays.
